(19) United States
(12) Patent Application Publication
(10) Pub. No.: US 2006/0061886 A1
(43) Pub. Date: Mar. 23, 2006

(54) System for setting and maintaining a gas atmosphere in an optical system

(76) Inventors: Bernhard Gellrich, Aalen (DE); Nils Dieckmann, Huettlingen (DE)

Correspondence Address: HOLLAND & KNIGHT LLP, Law Offices, One East Broward Boulevard, Suite 1300, Ft. Lauderdale, FL, 33301, US

(21) Appl. No.: 11/247,925

(22) Filed: Oct. 11, 2005

Related U.S. Application Data
(63) Continuation-in-part of application No. PCT/EP04/03559, filed on Apr. 3, 2004.

(30) Foreign Application Priority Data
Apr. 15, 2003 (DE) 103 17 201.7
Apr. 19, 2003 (DE) 103 18 003.6

(51) Int. Cl. G02B 7/02

(52) U.S. Cl. 359/811

(57) ABSTRACT

Arranged in a system for setting and maintaining a gas atmosphere in an objective having at least one optical element is a first, inner gas compartment that is separated from a second, outer gas compartment by an inner casing. Both gas compartments are provided with gas inlet and gas outlet openings. At least one of the two gas compartments is under a pressure that is higher than the ambient pressure.

### BACKGROUND OF THE INVENTION

1. Field of the invention

The invention relates to a system for setting and maintaining a gas atmosphere in an optical system, in particular in an objective, having at least one optical element that is situated in a first, inner gas compartment that is separated from a second, outer gas compartment by an inner casing, both gas compartments being provided with gas inlet and gas outlet openings.

The invention also relates to a projection exposure machine having an illuminating system and a projection objective for producing semiconductor elements.

2. Description of the Related Art

In illuminating systems having light sources that emit beams with very short wavelengths, in particular 157 nm or shorter, problems arise with contamination owing to water, oxygen and hydrocarbons that reduce the transmission. Instances of contamination occur in this case through diffusion from outside, through seals or narrow gaps in the optical system. It is therefore already known to provide an ultraclean atmosphere in the interior of an objective by flushing with appropriately cleaned flushing gas or by building up an overpressure while accepting leakages to the outside and continuously refilling in order to maintain the overpressure with appropriately cleaned gases.

Sealed gas compartments are, however, no longer adequate at these short wavelengths. Specifically, the gas atmosphere in objective interiors is extremely clean in this case. Consequently, the partial pressure for the contamination components outside the objective is so high that despite partitioning, instances of diffusion into the objective interior take place through unavoidable leaks. Moreover, contaminated compartments that cannot be reached by a conventional flushing gas stream are playing an ever greater role as source of contamination because the clean gas compartments can be contaminated starting from them over a relatively long time.

In order to achieve the required cleanliness, and thus a high light transmission inside the optics used, it is possible to use a multistage flushing concept such as is known from WO 99/50892.

WO 99/50892 describes a flushing concept in which the optical elements for imaging are arranged in an objective such that they are separated from the surroundings by two gas compartments. The inner gas compartment, in which the optical elements are arranged, is filled with a nonreacting or inert gas, an outer gas compartment likewise being filled with a gas which, however, need not exhibit the cleanliness of the gas of the inner gas compartment. The gas pressure in the inner gas compartment is set higher than in the outer gas compartment. Both gas compartments should be gastight in this case. This flushing concept requires a relatively large amount of installation space. Both chambers are intended in this case to be gastight.

EP 1 004 937 A2 discloses a projection objective providing a number of chambers that are lined up sequentially and can be opened independently of one another. For servicing purposes, the aim in this case is to be able to open individual chambers, the other chambers remaining sealed off and, if appropriate, separately flushed.

### SUMMARY OF THE INVENTION

The present invention is based on the object of improving a system of the type mentioned at the beginning in such a way as largely to prevent instances of contamination from the surroundings from penetrating an optical system in particular an objective.

A further object of the invention is to provide a system for an ultraclean gas atmosphere inside an optical system in a space-saving fashion.

This object is achieved according to the invention by virtue of the fact that at least one of the two gas compartments is under a pressure that is higher than the ambient pressure.

According to the invention, at least one of the two gas compartments, more specifically a first, inner gas compartment and/or a second, outer gas compartment, exhibits a higher pressure than the ambient pressure. It is possible thereby to reduce or prevent instances of contamination such as the deposition of water, oxygen or hydrocarbons onto the optical elements.

In an advantageous refinement of the invention, it can be provided that the second gas compartment is connected to the surroundings via one or more capillary openings.

The aim is now advantageously no longer a complete partitioning of the individual gas compartments in accordance with the prior art; instead, there is conscious provision of capillary openings which connect the inner gas compartment to the outer gas compartment and connect the outer gas compartment to the surroundings. The capillary openings constitute very small or hairline openings through which a flow takes place. By contrast with volumetric flow, however, no diffusion is intended to be present. Contamination components can be removed from the gas compartments in this way.

In a very advantageous development of the invention, it can be provided that the first gas compartment also is connected to the second gas compartment via one or more capillary openings.

Since it can additionally be provided in a further very advantageous refinement that a higher pressure prevails in the first, inner gas compartment than in the second, outer gas compartment, it is ensured that, as a result of the overpressure, a flow of gas takes place in the direction of the second, outer gas compartment via the capillary openings, contamination being carried along. Since the outer gas compartment is also still under a pressure that is higher than the ambient pressure, a further exchange of gas also takes place with the atmosphere.

Instead of the attempt to achieve complete sealing, something which it is virtually impossible to carry out in practice owing to instances of diffusion via seals and other connecting points, the overpressure according to the invention and the capillary opening now ensure that a targeted gas exchange takes place. However, this gas exchange is targeted to take place only to the outside, it thereby being possible to avoid instances of contamination. Even if a “contamination transfer” were to take place against the gas flow direction owing to high different partial pressures, it is possible to maintain high cleanliness in the inner gas compartment, since the outer gas compartment acts as a buffer, and a continuous or discontinuous gas exchange in the outer gas compartment already removes from this gas compartment contaminants penetrating from outside. Penetration of contamination from outside as far as into the inner gas compartment is likewise prevented in this way.

In a further advantageous refinement of the invention, it can be provided that the second, outer gas compartment is formed at least partially by flushing grooves arranged in mounts of the optical elements.

According to the invention, the second, outer gas compartment can now also be integrated at least partially in the mounts the optical elements, advantageously in the bearing surfaces of the mounts, a substantial saving of space thereby being achieved.

It is possible in a known way to use flushing in the inner part of the objective and in the flushing grooves to provide an ultrapure gas atmosphere that is required for achieving a high transmission, particularly at wavelengths of 157 nm, an improved flushing of the objective without additionally required mechanical parts and a greater need for installation space being achieved by the arrangement of the second flushing casing inside the mounts.

It is advantageously possible, furthermore, to provide that the flushing grooves in mounts situated next to one another are respectively interconnected by connecting channels.

In the case of mounts following one another with optical elements, the flushing grooves can be interconnected by connecting channels provided at the flushing grooves. This is advantageous to the extent that it is thereby possible to implement only a single second “flushing casing” for the entire objective and not only respectively for the individual mounts.

As gases, helium can be used for the inner gas compartment, and nitrogen or another inert gas for the outer gas compartment.

The capillary openings according to the invention can be fashioned by additionally provided bores. The additionally provided capillary bores in this case preferably connect regions that are not covered by the gas flow or are only partially covered to the respective outer gas compartment.

In an advantageous refinement, the capillary openings can be configured or be provided with an appropriate device such that the quantity of the gas flow through the capillary openings can be influenced.

The outer casing of the objective is provided in general with a temperature control device. In addition, the partition between the inner gas compartment and the outer gas compartment can now also be provided as inner casing with a temperature control device. In this way, the gas flow according to the invention achieves heat removal not only by thermal radiation but also by convection, a better temperature regulation for the objective thereby becoming possible.

An advantageous further refinement of the invention can consist in that devices arranged in the region of the first gas compartment, such as manipulators, and around which gas does not flow or flows only partially are encapsulated from the first gas compartment and connected via capillary openings to the second gas compartment or directly to the surroundings. This prevents contamination components from passing into the inner gas compartment from these-poorly flushed regions.

In the same way, devices arranged in the region of the second gas compartment and around which gas does not flow or flows only partially can be connected via capillary openings to the surroundings.

Owing to the solution according to the invention, it is not mandatory for the gas to have to be continually exchanged in the individual chambers; rather, if appropriate it is possible to undertake only periodic flushings. This holds, in particular, for the inner gas compartment. It is at least possible also to reduce the gas flow in the case of a continuous gas exchange, and this likewise leads to savings.

The capillary openings can advantageously also be provided at connecting points of the objective, for example of mounts, depending on appropriate gaps.

Further advantageous refinements and developments emerge from the remaining subclaims. Exemplary embodiments of the invention are illustrated in principle below.

### BRIEF DESCRIPTION OF THE DRAWINGS

FIG. 1 shows an illustration of the principle of a projection objective having a system according to the invention;

FIG. 2 shows an illustration of the principle of a mount, in side view;

FIG. 3 shows a side view of a number of interconnected mounts, with an illustration of connecting channels as parts of the projection objective; and

FIG. 4 shows a perspective view of two interconnected mounts for an alternative arrangement of the connecting channels.

### DETAILED DESCRIPTION

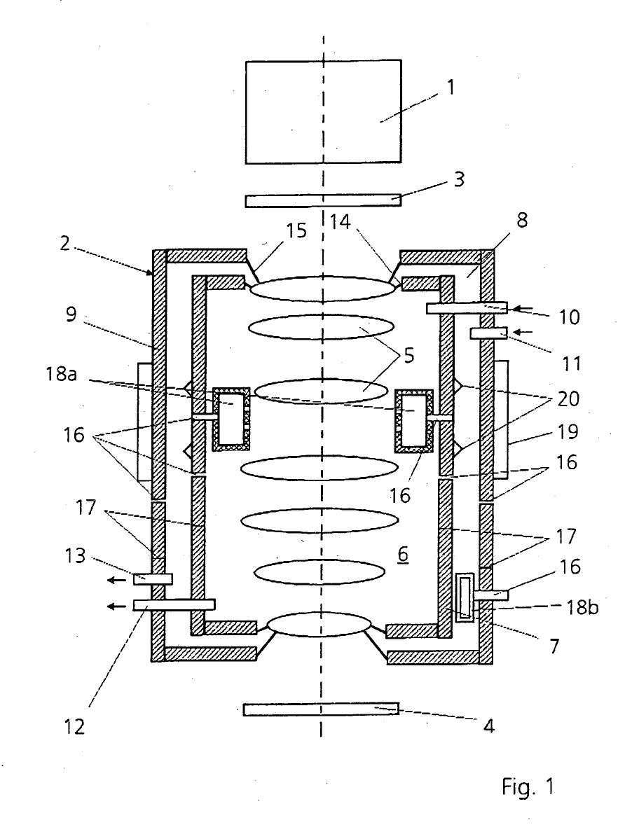

FIG. 1 is a schematic of a projection exposure machine having an illuminating system 1 that includes as light source, for example, a laser that emits beams with a wavelength of 157 nm or shorter. Located between the illuminating system 1 and a projection objective 2 is a reticle 3 in which the pattern to be imaged onto a wafer 4 on a reduced scale is introduced. The semiconductor elements to be produced are appropriately exposed on the wafer 4.

Arranged in the projection objective 2 are a multiplicity of optical elements, for example lenses 5 in a first, inner gas compartment 6 that is separated from a second, outer gas compartment 8 by an inner casing 7. The outer gas compartment 8 is separated from the surroundings by an outer casing 9 of the projection objective 2. Opening into the inner gas compartment 6 is a gas inlet opening 10, and opening into the outer gas compartment 8 is a further gas inlet opening 11. Located respectively on the side opposite the inlet side are a gas outlet opening 12, with an outlet line, for the inner gas compartment 6, and a gas outlet opening 13, with an outlet line, for the outer gas compartment 8.

In addition, seals 14 and 15 ensure sealing in the region of mounts.

One or more capillary openings 16 arranged distributed over the circumference and which produce a connection between the inner gas compartment 6 and the outer gas compartment 8 are provided in the inner casing 7. Further capillary openings are located in the outer casing 9 between the respective outer gas compartment 8 and the surroundings. In addition to or instead of the capillary openings 16, narrow gaps 17 at connecting points of flanges can also serve as capillary openings.

Helium flows continuously or discontinuously through the inner gas compartment 6 via the gas inlet opening 10 and the gas outlet opening 12. Clean nitrogen flows through the outer gas compartment 8 correspondingly via the gas inlet opening 11 and the gas outlet opening 13. The pressure in the inner gas compartment 6 is set in this case higher than the pressure in the outer gas compartment 8.

Capillary openings 16 can also be arranged in the region of the gas outlet openings 12 or 13 or in their outlet lines. As may further be seen from FIG. 1, one or more regions or devices 18a that are located in the interior of the inner gas compartment 6 are sealed off from this gas compartment. Manipulators for adjusting mounts of the optical elements 5 can, for example, be located in these regions. The regions 18a are likewise connected via capillary openings 16 in the inner casing 7 to the outer gas compartment 8. This avoids a transfer of contamination substances into the inner gas compartment 6. The regions or devices 18a can, of course, also be sealed off from the inner gas compartment 6 and be connected only via the capillary openings 16 to the outer gas compartment 8 or also directly to the surroundings.

A similar statement holds for regions or devices 18b that are located in the outer gas compartment 8 and that are likewise connected via capillary openings 16 to the surroundings.

The outer casing 9 can be provided on the outside with a temperature control device 19 that can be of arbitrary configuration. In addition or alternatively, the inner casing 7 or else the outer casing 9 can likewise be provided with temperature control devices 20 in the gas compartment 8, these being indicated only in principle in FIG. 1. Tubes or hoses arranged in the interior of the casing and in which cooling liquid circulates can, for example, be used as temperature control devices. It is likewise possible to use thermal conduction bands, cooling ribs, Peltier elements, heat pipes or the like. Sensors can be provided in the interior or on the surface of the inner casing 7 and/or the outer casing 9 in order to measure the respective temperatures.

The second, outer gas compartment 8 can be an integral component of a holding device for the optical elements (not illustrated in more detail). In this case, the gas inlet and gas outlet openings or the capillary openings are formed by grooves and holes that are drilled through the mounts. No casing is arranged around separately around them on the outside, in this instance.

It is likewise also possible to design the second, outer gas compartment 8 as an integral component of a support structure of the optical system (not illustrated in more detail). In this case, the support structure is sealed off and flushing is carried out between the support structure and the mounts.

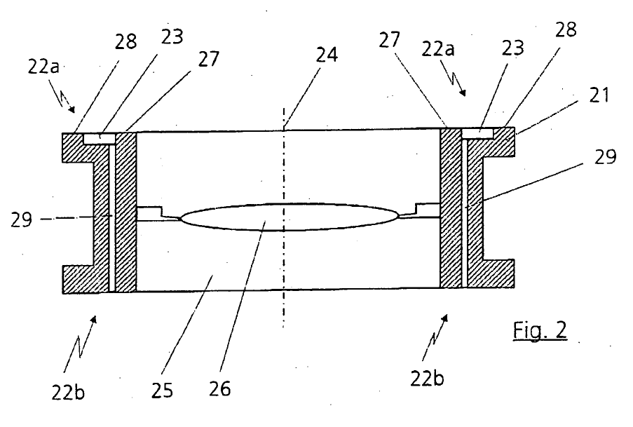

A further possibility for producing a gas atmosphere in an optical system is illustrated in FIG. 2.

FIG. 2 shows a mounting ring 21 that is of rotationally symmetrical design. The mounting ring 21 is provided in each case on either side with bearing surfaces 22a and 22b that also serve as sealing surfaces. In order for the bearing surfaces 22a and 22b to constitute straight surfaces that are as flat as possible, the bearing surfaces 22a and 22b can be treated with the aid of polishing or turning methods, for example. A flushing groove 23 can now respectively be introduced or milled into the mounting ring 21 at the upper bearing surface 22a. In this exemplary embodiment, the flushing groove 23 is introduced into the bearing surface 22a centrally. It is also possible for the flushing groove 23 to be arranged offset in the direction of the mechanical axis 24 of the mounting ring 21, or in the opposite direction. The peripheral flushing groove 23 can be separately flushed by a separate gas supply, for example by gas inlet openings and gas outlet openings not illustrated here, and therefore constitutes a second “flushing casing”.

As is known from the general prior art, flushing with gas is likewise carried out in a first, inner gas compartment 25. However, an ultrapure gas atmosphere should prevail here so that it is possible to achieve an adequately high transmission at wavelengths of λ=157 nm. For reasons of transmission, an oxygen content of approximately 1 ppm in the flushing gas should be set in the interior of the projection objective 2, which is not illustrated here as a whole but is marked only by a lens 26. This means that the oxygen content in the first, inner gas compartment 25 is to be kept very slight. The flushing groove 23 separates an inner sealing surface 27 from an outer sealing surface 28. Since the first, inner gas compartment 25 cannot be completely sealed off from the flushing groove 23 nor, in turn, can the latter be completely sealed off from the environment or surroundings, it is possible for sealants and lubricants or greases to be capable of being applied to the sealing surfaces 27 and 28 in order to improve the sealing.

The flushing gas in the flushing groove 23 can have an oxygen content of 100 ppm. There is thus a cascaded design, it already being possible to set a substantially improved cleanliness in the flushing groove 23 by comparison with the surroundings. In the case of a gas exchange from the flushing groove 23 into the first, inner gas compartment 25 (diffusion), it is nevertheless possible to achieve or maintain the desired oxygen content of 1 ppm in the first, inner gas compartment 25. An overpressure therefore prevails in the first, inner gas compartment 25. It should hold for the pressures in the two gas compartments 23 and 25 that: pᵢ>pₐ>pᵤ, pᵢ being the pressure of the first, inner gas compartment, pₐ being the pressure of the second, outer gas compartment, and pᵤ being the ambient pressure of the projection objective 2. The requirements placed on the quality of the sealing surfaces 27 and 28 can be substantially reduced owing to the cascaded design.

It is also possible for a number of mounting rings 21 on the bearing surfaces 22a and 22b to be interconnected, it being possible to interconnect the milled peripheral flushing grooves 23 by means of connecting channels 29.

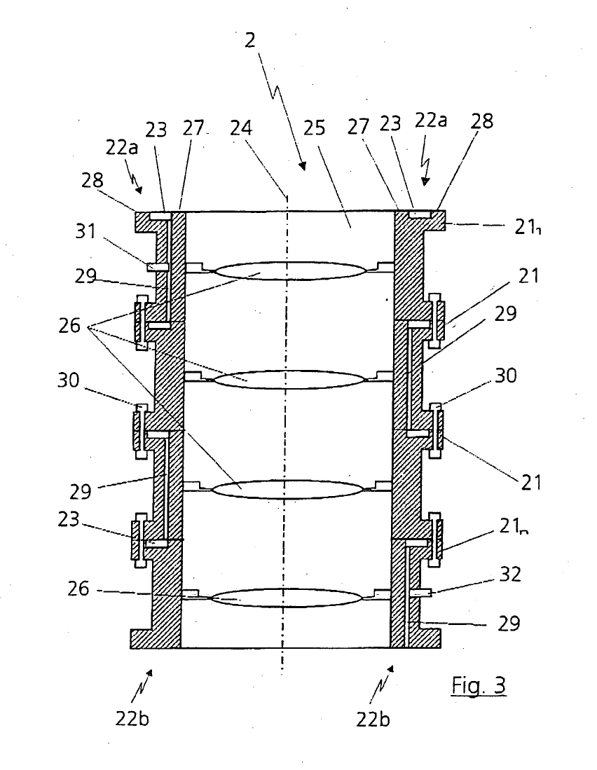

FIG. 3 shows a subregion of the projection objective 2 with a number of interconnected mounting rings 21. The mounting rings 21 are interconnected via screw interconnections 30. A gas inlet opening 31 is located at the uppermost mounting ring 21₁. A gas outlet opening 32 is located at the lowermost mounting ring 21ₙ. The individual flushing grooves 23 of the mounts 21 are interconnected via the connecting channels 29, it thereby being possible to implement a second gas compartment for the entire projection objective 2.

The flushing grooves 23 are respectively located only in the bearing surfaces 22a of the mounting rings 21. In order to achieve an improved “flushing”, it is advantageous that the connecting channels 29 emanating from the flushing grooves 23 be arranged in a fashion alternately offset from one another, the connecting channels 29 being arranged in this exemplary embodiment in a fashion respectively twisted by 180°. As a result of this arrangement, it is possible to implement a complete “flushing” in each region of the sealing surfaces 27 and 28. It is, of course, also possible for the flushing grooves 23 to be offset from one another only by a few degrees, in which case, however, it should be borne in mind that a complete “flushing” is a precondition for a high transmission.

The gas can be introduced into the connecting channel 29 through the gas inlet opening 31. If the gas is to be recaptured for reasons of environmental protection, it can be, removed at the gas outlet opening 32 by, for example, a pumping-off device (not illustrated).

First, inner gas compartment 25 and second, outer gas compartment (flushing groove) 23 can also be flushed separately such that inner gas compartment 25 and outer gas compartment 23 have separate gas inlet openings and gas outlet openings. It is thus possible to construct a pressure or cleanliness cascade in a controlled fashion.

The connecting channels 29 are integrated here in the mounting rings 21.

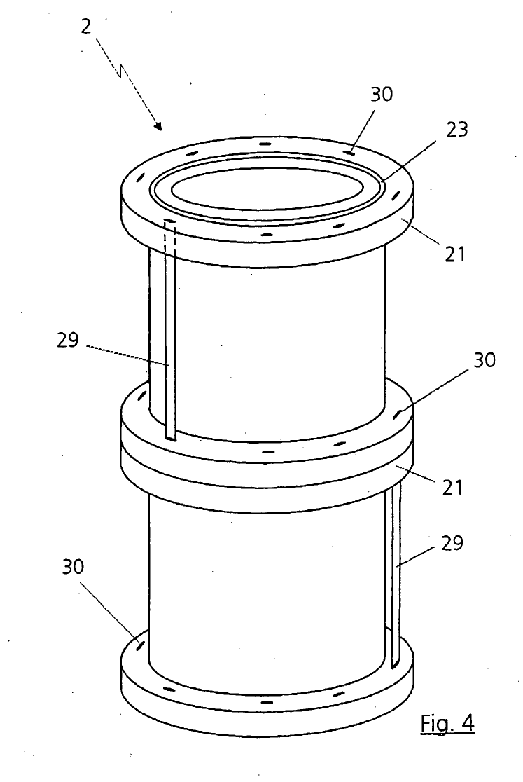

FIG. 4 shows a perspective illustration of two mounting rings 21 screwed to one another. In this exemplary embodiment, the connecting channels 29 are not integrated in the mounts 21 but run outside the mounts 21. The diameters of the connecting channels 29 can vary depending on the desired gas volume.

It would also be conceivable to mill a further flushing groove in the bearing surfaces 22b. Since a specific gas volume is a precondition, the two flushing grooves should be of symmetrical configuration, which means that one flushing groove 23 should have a smaller diameter, as a result of which the size of the gas volume is maintained after a further groove has been milled.

Since helium is less pressure-sensitive, it would be advantageous to use it as gas in the first, inner gas compartment 25. However, nitrogen would likewise also be conceivable.

Consequently, the gas volume can be kept small by means of the comparatively slight diameter of the flushing groove 23, the result of which is that less flushing gas is required in the flushing grooves 23.

It is, moreover, also possible for an approximately equal pressure of 1 ppm to prevail in the flushing grooves 23 as in the first, inner gas compartment 25. This has the advantage that a very high gas flow is present owing to the extremely small volume. It is likewise thereby possible to achieve the desired target cleanliness.

It would also further be possible to provide the outer sealing surface 28 of the mounting ring 21 with an O-ring seal. The required accuracy can thereby be achieved over the inner sealing surface 27.

What is claimed is:

1. A gas atmosphere dosing system in an optical system having at least one optical element that is situated in a first, inner gas compartment that is separated from a second, outer gas compartment by an inner casing, wherein both gas compartments are provided with gas inlet and gas outlet openings and at least one of said two gas compartments is under a pressure that is higher than the ambient pressure.

2. The system as claimed in claim 1, wherein said two gas compartments are respectively under a pressure that is higher than the ambient pressure.

3. The system as claimed in claim 1, wherein said second gas compartment is connected to the surroundings via one or more openings.

4. The system as claimed in claim 3, wherein said first gas compartment is connected to said second gas compartment via one or more openings.

5. The system as claimed in claim 1, wherein a higher pressure is provided in said first, inner gas compartment than in said second, outer gas compartment.

6. The system as claimed in claim 1, wherein an approximately equal pressure or higher pressure is provided in said second, outer gas compartment than in said first, inner gas compartment.

7. The system as claimed in claim 1, wherein said second, outer gas compartment is separated from the surroundings by an outer casing.

8. The system as claimed in claim 1, wherein said two gas compartments are provided with separate gas inlet and gas outlet openings.

9. The system as claimed in claim 1, wherein said second, outer gas compartment is formed at least partially by flushing grooves arranged in mounts of the optical elements.

10. The system as claimed in claim 9, wherein said flushing grooves are introduced in the bearing surfaces of the mounts.

11. The system as claimed in claim 10, wherein said flushing grooves are respectively arranged between inner sealing surfaces and outer sealing surfaces.

12. The system, as claimed in claim 9, wherein said flushing grooves in mounts situated next to one another are respectively interconnected by connecting channels.

13. The system as claimed in claim 12, wherein flushing grooves and/or connecting channels are additionally provided in intermediate rings arranged in intermediate mounts.

14. The system as claimed in claim 12, wherein said connecting channels emanating from the flushing grooves are arranged in a fashion alternately offset from one another.

15. The system as claimed in claim 12, wherein a number of mounts with flushing grooves comprise a common gas inlet opening and a common gas outlet opening.

16. The system as claimed in claim 2, wherein said pressures in the gas compartments can be regulated.

17. The system as claimed in claim 1, wherein said gas compartments comprise different gas concentrations.

18. The system as claimed in claim 1, wherein the gas in-said first gas compartment can be exchanged.

19. The system as claimed in claim 1, wherein the gas in said second gas compartment can be exchanged.

20. The system as claimed in claim 7, wherein said openings are adjustable.

21. The system as claimed in claim 8, wherein said openings are adjustable.

22. The system as claimed in claim 7, wherein said openings are located in the region of the outlet openings or of the outlet lines.

23. The system as claimed in claim 8, wherein said openings are located in the region of the outlet openings or of the outlet lines.

24. The system as claimed in claim 8, wherein helium is located in said first gas compartment.

25. The system as claimed in claim 5, wherein nitrogen is located in said second gas compartment.

26. The system as claimed in claim 7, wherein said opening is formed as gap at connecting points between the optical elements and their mounts.

27. The system as claimed in claim 8, wherein said opening is formed as gap at connecting points between the optical elements and their mounts.

28. The system as claimed in claim 1, wherein said second gas compartment is an integral component of a holding device for the optical elements.

29. The system as claimed in claim 1, wherein said second gas compartment is an integral component of a support structure of the optical system.

30. The system as claimed in claim 1, wherein the optical system is an objective.

31. The system as claimed in claim 30, wherein said objective is provided as a projection objective for semiconductor lithography.

32. The system as claimed in claim 31, wherein said projection objective is provided for exposures with wavelengths of 157 nm and shorter.

33. The system as claimed in claim 1, wherein devices arranged in the region of said first gas compartment and around which gas does not flow or flows only partially are encapsulated from said first gas compartment and connected via openings to said second gas compartment or directly to the surroundings.

34. The system as claimed in claim 33, wherein the devices comprise manipulators.

35. The system as claimed in claim 1, wherein devices arranged in the region of said second gas compartment and around which gas does not flow or flows only partially are connected via openings to the surroundings.

36. The system as claimed in claim 1, wherein said first gas compartment is provided with temperature control devices.

37. The system as claimed in claim 36, wherein said temperature control devices are arranged on the inner casing or on the outer casing in one of said two gas compartments.

38. A projection exposure machine having an illuminating system and a projection objective for producing semiconductor elements, wherein the projection objective is provided with at least one optical element that is situated in a first, inner gas compartment that is separated from a second, outer gas compartment by an inner casing, wherein both gas compartments are provided with gas inlet and gas outlet openings and at least one of said two gas compartments is under a pressure that is higher than the ambient pressure.

39. The projection exposure machine as claimed in claim 38, wherein said second gas compartment is connected to the surroundings via one or more openings.

40. The projection exposure machine as claimed in claim 39, wherein said first gas compartment is connected to said second gas compartment via one or more openings.

41. The projection exposure machine as claimed in claim 38, wherein said second, outer gas compartment is formed at least partially by flushing grooves arranged in mounts of the optical elements.

42. The projection exposure machine as claimed in claim 41, wherein said flushing grooves are introduced in the bearing surfaces of the mounts.

43. A gas atmosphere dosing system in an optical system that is situated in a first gas compartment that is separated from a second gas compartment, wherein both gas compartments are provided with gas inlet and gas outlet openings and wherein devices arranged in the region of said first gas compartment are encapsulated from said first gas compartment and connected via openings to said second gas compartment or directly to the surroundings.

44. The system as claimed in claim 43, wherein said first gas compartment is under a pressure that is higher than the ambient pressure.

45. The system as claimed in claim 43, wherein a higher pressure is provided in said first gas compartment than in said second gas compartment.

46. A gas atmosphere dosing system in an optical system that is situated in a first gas compartment that is separated from a second gas compartment, wherein both gas compartments are provided with gas inlet and gas outlet openings and wherein devices arranged in the region of said second gas compartment are connected via openings to the surroundings.

47. The system as claimed in claim 46, wherein said first gas compartment is under a pressure that is higher than the ambient pressure.

48. The system as claimed in claim 46, wherein a higher pressure is provided in said first gas compartment than in said second gas compartment.

49. A gas atmosphere dosing system in an optical system that is situated in a gas compartment which is provided with gas inlet and gas outlet openings, and which is sealed off from regions in which devices are located, wherein said regions are connected via openings to the surroundings.

50. The system as claimed in claim 49, wherein said first gas compartment is under a pressure that is higher than the ambient pressure.

51. The system as claimed in claim 43, 46 or 47, wherein said optical system is an objective.

52. The system as claimed in claim 43, 46 or 47, wherein said devices comprise manipulators.
